(19) United States
(12) Patent Application Publication
(10) Pub. No.: US 2007/0172808 A1
(43) Pub. Date: Jul. 26, 2007

(54) Adaptive diagnostic assessment engine

(75) Inventor: Richard William Capone, Kensington, CA (US)

Correspondence Address: TRAN & ASSOCIATES, 6768 MEADOW VISTA CT., SAN JOSE, CA, 95135, US

(73) Assignee: LET'S GO LEARN, INC.

(21) Appl. No.: 11/340,734

(22) Filed: Jan. 26, 2006

(51) Int. Cl. G09B 3/00

(52) U.S. Cl. 434/350; 434/362

(57) ABSTRACT

Systems and methods provide educational adaptive diagnostic assessment of student performance by: a. receiving one or more parameters for an assessment and one or more sets of test questions for a sub-test; b. selecting a set of test questions from the sub-test; c. presenting the selected set of test questions to the student and collecting responses thereto; d. generating a score for the responses to a completed set; e. applying the score to select either the current set of questions or a new set of test questions; and f. repeating (c)-(e) for the subtest; and g. using a final score for the sub-test to select a new set of questions in a subsequent sub-test.

This application is related to application Ser. No. ______, filed on Jan. 26, 2006 and entitled “SYSTEMS AND METHODS FOR GENERATING READING DIAGNOSTIC ASSESSMENTS”, the content of which is incorporated by reference.

### BACKGROUND

Educators, employers, researchers, and other users constantly attempt to assess students and employee's abilities or their thoughts or feelings and attain immediate feedback. The data is used to determine a path to take based upon instant results. For example, in education, it is particularly important to understand how and what students learned or like before moving forward in a curriculum.

Traditionally, polling has been used to provide immediate feedback. The methods to utilize polling may be limited to a single function device or a proprietary device or even manually. Furthermore, the information provided is a very limited and the ability for users to customize and create new uses may be limited. Additionally, polling may be also be limited by the fact that it only provides a single choice response.

Rubrics and checklists have also been used to grade performance or perform assessments. A rubric is a grid of objectives to be assessed and defined levels of accomplishment. While a rubric provides defined levels of achievement, many applications only require a checklist. A checklist is a specific item to be assessed. Often, it requires a pass/fail grade. For example, if a user needs to inspect a device or a house's roof, it typically requires a simple pass/fail rating. Sometimes, users have applications that require not only a pass/fail, but also a score. Also, the information and methods of collecting the information by traditional rubrics/checklists is limited and time consuming. Furthermore, the information provided is limited and does not allow raters to use the results in very helpful formats. The results may not provide enough detailed information with regard to aggregating information for group reporting or judging an event. The information may not be output in an immediate, timely manner as well.

United States Patent Application 20050233295 discloses a data collection and scoring system for performance assessments wherein the system has the facility for creating, editing, and scoring various rubrics and checklists, for maintaining a library of rubrics and checklists to download and use or edit, for utilizing either a PC or a mobile handheld computer to create, edit, or score the assessments, for uploading and downloading data between the PC and the handheld computer, and for creating customizable, objective scoring systems for subjective assessments. The system may be used for any performance or observable assessment including but not limited to, writing exams, listening exams, speaking exams, judging contests, driver's exams, physical education skills, music skills, vocational-technical course skills, employee reviews, and/or any type of inspection whether it's inspecting a person, a building, a mechanism, a component, a process, or anything that can potentially be inspected.

### SUMMARY

Systems and methods provide educational adaptive diagnostic assessment of student performance by:

a. receiving one or more parameters for an assessment and one or more sets of test questions for a sub-test;

b. selecting a set of test questions from the sub-test;

c. presenting the selected set of test questions to the student and collecting responses thereto;

d. generating a score for the responses to a completed set;

e. applying the score to select either the current set of questions or a new set of test questions; and

f. repeating (c)-(e) for the subtest; and

g. using a final score for the sub-test to select a new set of questions in a subsequent sub-test.

Implementations of the above system may include one or more of the following. The parameters can be a number of subtests; a number of sets of questions for each subtest; a number of questions per set of questions; an assessment starting point; a grade level; a student age; a prior score; a parameter specifying a transition between subtests; a parameter specifying a movement within a subtest; a termination condition for each subtest; a termination condition for the assessment; a graphical interface parameter; an audio parameter; or a summary score formula. The student can access the system over a wide area network such as the Internet. The student can log in using a student identifier and a password, or the student can respond to test questions through a teacher management application, or the student can respond to test questions through a third party application having a security key code. The assessment can begin based on: a grade level, an age, a student type, or a previous test score from a completed assessment. The scoring of the student's response can include checking a multiple choice answer or checking an exact match to an answer, checking a partial match to an answer, or comparing a student response time to a question against a predetermined time limit. The score can be expressed as a percentage of correct responses to a set of test questions. The student can be presented with an easier or harder set of test questions. The process can select the new set of test questions based on a variable jump threshold, such as jumping forward or backward in difficulty by 1 level, 2 levels, 3 levels, or any suitable levels or by a non-constant varying of the levels between sets. The score can be determined from a completed or partially completed subtest is used to select the new set of test questions. The process can affect a set change based on one of: a student age, a student grade, a student type. The process can transition to a new sub-test based on the score. The current subtest can be terminated based on one of: achieving a pattern of mastery of adjacent sets of questions; completing the highest level set within the subtest; reaching a predetermined number of errors; generating a pattern of errors during the subtest. The process can determine a starting point within a new subtest using multiple parameters, which can be a summary score of an earlier subtest in the same assessment or a summary score of the subtest in an earlier completed assessment. The process can terminate an assessment if all subtests have been completed, skipped, or terminated, or if all subtests selected by a test administrator have been completed. The process can reward the student at the end of the assessment, such as displaying a rewards page selected based on the student's age, grade, type, and assessment type. The student can be transferred to an instructional program based the assessment. The instructional program in turn can benefit from the assessment data generated by the engine for instruction differentiation. The system can also transfer the student to a third party student management system where the student originated. The system can display a summary page with prescriptive or summary information on the assessment results.

Advantages of the system may include one or more of the following. The system provides educators, parents and employers with an immediate feedback, an ability to create and edit these tools at any time, anywhere, an ability to score and store the data in a remote location and to upload to a computer at a later time, and an ability to aggregate the data from multiple scorers. The system automates the time-consuming diagnostic assessment process and provides an unbiased, consistent measurement of progress. The system provides teachers with specialist expertise and expands their knowledge and facilitates improved classroom instruction. Benchmark data can be generated for existing instructional programs. Diagnostic data is advantageously provided to target students' strengths and weaknesses in the fundamental sub-skills of reading and math, among others. The data paints an individual profile of each student and tracks ongoing reading progress objectively over a predetermined period. The system collects diagnostic data for easy reference and provides ongoing aggregate reporting by school or district. Detailed student reports are generated for teachers to share with parents. Teachers can see how students are doing in assessment or instruction. Day-time teachers can view student progress, even if participation is after-school, through an ESL class or Title I program, or from home. Moreover, teachers can control or modify educational track placement at any point in real-time.

Other advantages may include one or more of the following. The reading assessment the system allows the teacher to expand his or her reach to struggling readers and acts as a reading specialist when too few or none are available. The math assessment system allows the teacher to quickly diagnose the student's number and measurement skills and shows a detailed list of skills mastered by each math construct. Diagnostic data is provided to share with parents for home tutoring or with tutors or teachers for individualized instructions. All assessment reports are available at any time. Historical data is stored to track progress, and reports can be shared with tutors, teachers, or specialists. For parents, the reports can be used to tutor or teach your child yourself. The web-based system can be accessed at home or when away from home, with no complex software to install.

Other advantages and features will become apparent from the following description, including the drawings and claims.

### BRIEF DESCRIPTION OF THE DRAWINGS

Referring now to the drawings in greater detail, there is illustrated therein structure diagrams for an educational adaptive assessment system and logic flow diagrams for the processes a computer system will utilize to complete various real estate transactions. It will be understood that the program is run on a computer that is capable of communication with consumers via a network, as will be more readily understood from a study of the diagrams.

FIG. 1 shows an exemplary process for providing educational adaptive diagnostic assessment.

FIG. 2 shows an exemplary client-server system that provides educational adaptive diagnostic assessment.

### DESCRIPTION

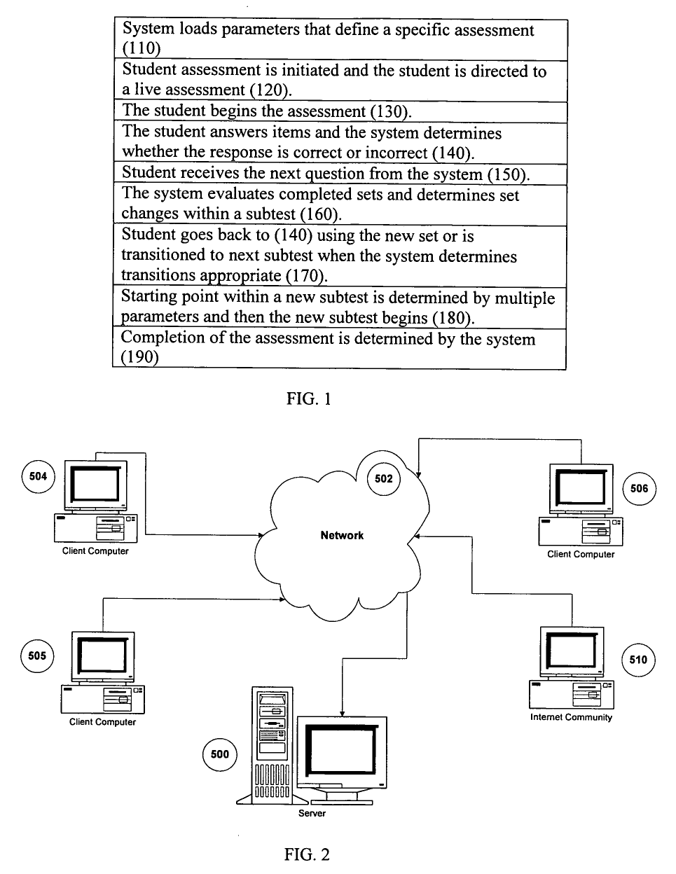

FIG. 1 shows an exemplary process operative in an adaptive diagnostic assessment engine. In this process, the engine receives parameters that define a specific assessment (110). Among others, the parameters can include one or more of the following:
1) number of subtests in an assessment
2) number of sets per subtest
3) number of questions per set (can be variable between sets)
4) student parameters to use to determine assessment starting point
   a. i.e. grade level of student, age of student
   b. i.e. previous summary scores of student
5) transition between subtest parameters which determines how student will transition from one subtest to the next and whether subtests may be skipped or included.
6) Movement within a subtest which examines how students are moved within a subtest based on their performance on any particular set or multiple sets.
7) Termination conditions for each subtest and for the entire assessment
8) Graphical interface parameters such as trigger conditions for loading particular learning modules on the student's computer to deliver the questions and answers.
9) Audio parameters which determine audio file versions to be presented to a particular test-taker. For example, younger test-takers hear simple instructions and more motivational words while older test-takers hear more straight forward instructions that may use language at a higher grade level.
10) Summary score formula from each subtest if it is being scored.

Once parameters have been loaded, a student assessment test is initiated and the student is directed to a live assessment (120). The student enters the system through three pathways: For example, the student can log-in using a valid student log-in and password directly into the system. A teacher who is already logged into a teacher management application can allow the student to begins or continue a student assessment. Third-party companies who are suitably authorized can initiate an external account handshake which delivers a student directly into the system. This one way communication sends student information and a security key code. In real-time validation occurs and the assessment is begun.

The assessment process is initiated and a presentation and/or a question is presented to the student (130). The assessment can be based on his/her grade level, age, student type, or previous test scores from a completed assessment of the same type. The student responds with answers to questions or items and the system determines whether the student's response is correct or incorrect (140).

Any of the following conditions or all may be used to determine whether a response is correct or incorrect: 1) the system can compare the multiple choice question's answer to the student's multiple choice selection; 2) the system can compare a typed student response and compare the typed response to a question's correct answer for exact and/or partial match conditions; and 3) the system can examine student response time and compare the response time to a time limit conditions.

The student receives the next question from the system (150) and the system evaluates completed sets and determines set changes within a subtest (160). Sets can be made up of one or more questions. For example, the sets can be based on a percentage of correct responses in a set can move students to high or lower sets at variable jump sizes. The set can also be selected based on results from other completed or partially completed subtests can affect set changes in this current subtest. Alternatively, ceiling conditions determined by student's age, grade, type can affect set changes

The student goes back to step four in the new set or is transitioned to next subtest when the system determines transitions appropriate (170). The following conditions may be used to determine when a transition should occur:
1) Mastery of a set is determined by specific assessment subtest parameters.
2) Adjacent set results of a mastered set above a non-mastered set can trigger termination of a subtest
3) Pattern of mastery and/or non-mastery of adjacent sets can determine termination of a subtest.
4) Completion of highest level set within a subtest can determine termination of a subtest.
5) Total number of errors in a set may trigger termination of a subtest.
6) Pattern of errors of a subtest may trigger termination of a subtest.

A starting point within a new subtest is determined by multiple parameters and then the new subtest begins (180). In one embodiment, the following are parameters may be used: 1) summary scores of a completed/terminated earlier subtest in the same assessment; 2) summary score of the same subtest in an earlier administered completed assessment; or calculations on multiple summary scores on multiple subtests that have just been completed in the same assessment.

The system determines whether the assessment is completed (190). Various conditions can affect the completion of the assessment. For example, if all subtests have been completed, skipped, or terminated the assessment is finished. Alternatively, if all subtests that have been marked by the test administrator or teacher have been completed then the assessment is finished. This is for the cases where test administrators may target only certain subtests to be given in an assessment that contains multiple subtests.

Optionally, the students who completed the assessment may be sent to a reward page that rewards him/her with entertaining graphics for completing the assessment. The rewards page is selected based on the student's age, grade, type, and assessment type. The student can also transferred to one of the following: a log out page; an instructional program related to the assessment and uses the data for differentiation; a third party student management system from where the student originated; or a summary page that provides the student with prescriptive or summary information on his or her assessment results.

One embodiment of FIG. 1 is an Online Adaptive Assessment System for Individual Students (OAASIS). The OAASIS assessment engine resides on a single or multiple application server accessible via the web or network. It controls the logic of how students are assessed. It is independent of the subject being tested. Assessments are defined to OAASIS via a series of parameters that control how adaptive decisions are made while student are taking an assessment in real-time. Furthermore, OAASIS references multiple database tables that hold the actual test times. OAASIS will pull from various tables as it reacts to answers from the test-taker. During use OAASIS can work across multiple computer processors on multiple servers. Students can perform an assessment and in real-time OAASIS will distribute its load to any available CPU.

The above embodiment of the adaptive diagnostic engine is an expert system that adaptively determines the set of questions to be presented to the student based on his or her prior performance. The expert system is based on rules that are communicated as parameters to the engine prior to running the assessment. Instead of the expert system, other data mining systems can be used. For example, in one embodiment, manual classification techniques can be used. Manual classification requires individuals to assign each output to one or more categories. These individuals are usually domain experts who are thoroughly versed in the category structure or taxonomy being used. In other embodiments, an automated classifier can be used to mine data arising from the test results. The classifier is a k-Nearest-Neighbor (kNN) based prediction system. The prediction can also be done using Bayesian algorithm, support vector machines (SVM) or other supervised learning techniques. The supervised learning technique requires a human subject-expert to initiate the learning process by manually classifying or assigning a number of training data sets of image characteristics to each category. This classification system first analyzes the statistical occurrences of each desired output and then constructs a model or “classifier” for each category that is used to classify subsequent data automatically. The system refines its model, in a sense “learning” the categories as new images are processed. Alternatively, unsupervised learning systems can be used. Unsupervised Learning systems identify groups or clusters of related image characteristics as well as the relationships between these clusters. Commonly referred to as clustering, this approach eliminates the need for training sets because it does not require a preexisting taxonomy or category structure.

During operation, a student logs on-line and based on the parameters, is presented with a presentation and one or more follow-up questions selected from a set of questions. The presentation can be a multimedia presentation including sound, image, animation, video and text. The student is tested for comprehension of the concept and the diagnostic engine presents additional questions in this concept based on the student's performance on earlier questions. The process is repeated for additional concepts based on the test-taker's performance on earlier concepts. When it is determined that additional concepts do not need to be covered for a particular test-taker, the test halts. Prescriptive recommendations and diagnostic test results are compiled in real-time when requested by parents or teachers by data mining the raw data and summary scores of any student's particular assessment.

In one embodiment, the engine of FIG. 1 is configured to perform Diagnostic Online Reading Assessment (DORA) where the system assesses students' skills in reading by looking at seven specific reading measures. Initial commencement of DORA is determined by the age, grade, or previously completed assessment of the student. Once the student begins, DORA looks at his or her responses to determine the next question to be presented, the next set, or the next subtest. The three subtests deal with the decoding abilities of a student, high-frequency words, word recognition, and phonics (or word analysis) examine at how students decode words. The performance of the student on each subtest as they are presented affects how he or she will transition to the next subtest. For example a student who performs below grade level on the first high-frequency word subtest will start at a set below his or her grade level in word recognition. The overall performance on the first three subtests as well as the student's grade level will determine whether the fourth subtest, phonemic awareness is presented or skipped. For example students who perform at third or above grade level in high-frequency word, word recognition, and phonics will skip the phonemic awareness subtest. But if the student is at the kindergarten through second grade level he or she will perform the phonemic awareness subtest regardless of his or her performance on the first three subtests. Phonemic awareness is an audio only subtest. This means the student doesn□t have to have any reading ability to respond to its questions. The next subtest is word meaning also called oral vocabulary. It measures a student's oral vocabulary. Its starting point is determined by the student's age and scores on earlier subtests. Spelling is the sixth subtest. Its starting point is also determined by earlier subtests. The final subtest is reading comprehension also called silent reading. The starting point is determined by the performance of the student on word recognition and word meaning. On any subtest, student performance is measured as they progress through items. If test items are determined to be too difficult or too easy jumps to easier or more difficult items may be triggered. Also in some cases the last two subtests of spelling and silent reading may be skipped if the student is not able to read independently. This is determined by subtests one to three.

The engine can be adapted through the parameters provided to the engine. These parameters are discussed next for an exemplary reading subtest. In this example, for the first reading sub-test, a high water value indicates the highest score that a student achieved in any particular subtest and as students master new sets their score moves up to a higher level. Scores start off as the minimum score and then increase. The parameters specify that each grade has 3 sets of 8 questions per grade for a total of 9 sets of questions. The 3 sets in each grade correspond to low, mid or high level mastery. The parameters also indicate the starting points for grades 1-2 to start at set 1; grades 3-4 to start at set 4; grade 5-6 to start at set 7; and for the remaining grades to start at set 9.

The parameters specify conditions for providing more advanced test questions to advanced students who have mastered the materials. For example, the parameters specify that 6 or more correct responses for each set of 8 questions is considered mastery and thus sets a new high water. If the student answers 7 or 8 questions correctly per set, the student is advanced 2 sets of questions (unless the student is near the end, then he or she is advanced 1 set of questions. If the student answers 6 responses correctly per set, he or she is advanced 1 set of questions.

The parameters also specify the termination of the tests for students who are not making satisfactory progress. For example, if the student scores 5 or less correct responses, the test terminates if the prior set of questions has not been completed. The parameters can move the student back as follows: 0 to 2 correct responses from the student move the student back 2 sets of questions, while 3 to 5 correct responses move the student back 1 set of questions.

The parameters also specify the transition to the next subtest. For example, if the final score of the current subtest is between 0.5 and 2.17, then the student begins the next subtest at grade 1 (set 1). If the final score is between 2.5 and 2.83 then the student starts the next subtest at grade 2 (set 2). If the final score is 3.17 and 3.5 then the student starts the next subtest at grade 3 (set 3). The parameters can also be tied to the score and the grade level. For example, if the final score is 3.83 AND student's grade is 4 or less, the student starts the next subtest at grade 4 (set 4). If the final score is 3.83 AND the student's grade is 5 to 7, start at grade 6 (set 6), and if the final score is 3.83 AND student's grade is 8 or higher, the student starts the next subtest at grade 8 (set 8).

In one embodiment called Diagnostic Online Reading Assessment (DORA), the system assesses students in reading by looking at seven specific reading measures. Initial commencement of DORA is determined by the age, grade, or previously completed assessment of the student. Once the student begins, DORA looks at his or her responses to determine the next question to be presented, the next set, or the next subtest. The three subtests deal with the decoding abilities of a student, high-frequency words, word recognition, and phonics (or word analysis) examine at how students decode words. The performance of the student on each subtest as they are presented affects how he or she will transition to the next subtest. The overall performance on these subtests as well as the student's grade level will determine whether the fourth subtest, phonemic awareness is presented or skipped. Phonemic awareness is an audio subtest. This means the student doesn't have to have any reading ability to respond to its questions. The next subtest is word meaning also called oral vocabulary. It measures a student's oral vocabulary. Its starting point is determined by the student's age and scores on earlier subtests. Spelling is the sixth subtest. Its starting point is also determined by earlier subtests. The final subtest is reading comprehension also called silent reading. The starting point is determined by the performance of the student on word recognition and word meaning. On any subtest, student performance is measured as they progress through items. If test items are determined to be too difficult or too easy jumps to easier or more difficult items may be triggered. Also in some cases the last two subtests of spelling and silent reading may be skipped if the student is not able to read independently. This is determined by subtests one to three.

FIG. 2 shows an exemplary on-line system for adaptive diagnostic assessment. A server 500 is connected to a network 502 such as the Internet. One or more client workstations 504-506 are also connected to the network 502. The client workstations 504-506 can be personal computers or workstations running browsers such as Mozilla or Internet Explorer. With the browser, a client or user can access the server 500's Web site by clicking in the browser's Address box, and typing the address (for example, www.vilas.com), then press Enter. When the page has finished loading, the status bar at the bottom of the window is updated. The browser also provides various buttons that allow the client or user to traverse the Internet or to perform other browsing functions.

An Internet community 510 with one or more educational companies, service providers, manufacturers, or marketers is connected to the network 502 and can communicate directly with users of the client workstations 504-506 or indirectly through the server 500. The Internet community 510 provides the client workstations 504-506 with access to a network of educational specialists.

Although the server 500 can be an individual server, the server 500 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 500 supports an educational portal that provides a single point of integration, access, and navigation through the multiple enterprise systems and information sources facing knowledge users operating the client workstations 504-506. The portal can additionally support services that are transaction driven. Once such service is advertising: each time the user accesses the portal, the client workstation 504 or 506 downloads information from the server 500. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal. Additionally, the portal offers contents and forums providing focused articles, valuable insights, questions and answers, and value-added information about related educational issues.

The server enables the student to be educated with both school and home supervision. The process begins with the reader's current skills, strategies, and knowledge and then builds from these to develop more sophisticated skills, strategies, and knowledge across the five critical areas such as areas identified by the No Child Left Behind legislation. The system helps parents by bridging the gap between the classroom and the home. The system produces a version of the reading assessment report that the teacher can share with parents. This report explains to parents in a straightforward manner the nature of their children's reading abilities. It also provides instructional suggestions that parents can use at home.

The above system can be implemented as one or more computer programs. Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method to provide educational adaptive diagnostic assessment of student performance, comprising:
a. receiving one or more parameters for an assessment and one or more sets of test questions for a sub-test;
b. selecting a set of test questions from the sub-test;
c. presenting the selected set of test questions to the student and collecting responses thereto;
d. generating a score for the responses to a completed set;
e. applying the score to select either the current set of questions or a new set of test questions; and
f. repeating (c)-(e) for the subtest; and
g. using a final score for the sub-test to select a new set of questions in a subsequent sub-test.

2. The method of claim 1, wherein the parameters comprise one or more of: a number of subtests; a number of sets of questions for each subtest; a number of questions per set of questions; an assessment starting point; a grade level; a student age; a prior score; a parameter specifying a transition between subtests; a parameter specifying a movement within a subtest; a termination condition for each subtest; a termination condition for the assessment; a graphical interface parameter; an audio parameter; a summary score formula.

3. The method of claim 1, comprising accessing the system over a wide area network.

4. The method of claim 3, wherein the student logs in using a student identifier and a password.

5. The method of claim 3, wherein the student responds to test questions through a teacher management application.

6. The method of claim 3, wherein the student responds to test questions through a third party application having a security key code.

7. The method of claim 1, wherein the student begins the assessment based on one of: a grade level, an age, a student type, a previous test score from a completed assessment.

8. The method of claim 1, wherein the scoring comprises checking a multiple choice answer or checking an exact match to an answer.

9. The method of claim 1, wherein the scoring comprises checking a partial match to an answer.

10. The method of claim 1, wherein the scoring comprises comparing a student response time to a question against a predetermined time limit.

11. The method of claim 1, wherein the score comprises a percentage of correct responses to a set of test questions.

12. The method of claim 1, wherein the student is presented with an easier or harder set of test questions.

13. The method of claim 1, comprising selecting the new set of test questions based on a variable jump threshold.

14. The method of claim 1, wherein the score from a completed or partially completed subtest is used to select the new set of test questions.

15. The method of claim 1, comprising affecting a set change based on one of: a student age, a student grade, a student type.

16. The method of claim 1, comprising transitioning to a new sub-test based on the score.

17. The method of claim 1, comprising terminating the subtest based on one of: achieving a pattern of mastery of adjacent sets of questions; completing the highest level set within the subtest; reaching a predetermined number of errors; generating a pattern of errors during the subtest.

18. The method of claim 1, comprising determining a starting point within a new subtest using multiple parameters.

19. The method of claim 18, wherein the parameters comprise one of: a summary score of an earlier subtest in the same assessment; a summary score of the subtest in an earlier completed assessment.

20. The method of claim 1, comprising terminating an assessment if all subtests have been completed, skipped, or terminated.

21. The method of claim 1, comprising terminating an assessment if all subtests selected by a test administrator have been completed.

22. The method of claim 1, comprising rewarding the student at the end of the assessment.

23. The method of claim 1, comprising displaying a rewards page selected based on the student's age, grade, type, and assessment type.

24. The method of claim 1, comprising transferring the student to an instructional program based the assessment.

25. The method of claim 24, wherein the instructional program uses assessment data for instruction differentiation.

26. The method of claim 1, comprising transferring the student to a third party student management system where the student originated.

27. The method of claim 1, comprising displaying a summary page with prescriptive or summary information on the assessment results.
